(19) United States
(12) Patent Application Publication
(10) Pub. No.: US 2004/0035924 A1
(43) Pub. Date: Feb. 26, 2004

(54) System and method for replacing identification data on a portable identification device

(76) Inventor: Joel Gaillard, Nassau NP. (BS)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/646,650

(22) Filed: Aug. 21, 2003

Related U.S. Application Data
(63) Continuation of application No. PCT/IB02/00652, filed on Mar. 5, 2002.
(60) Provisional application No. 60/276,119, filed on Mar. 16, 2001.
(60) Provisional application No. 60/294,448, filed on May 30, 2001.

(30) Foreign Application Priority Data
May 28, 2001 (WO) PCT/IB01/00940

(51) Int. Cl. G06F 17/60

(52) U.S. Cl. 235/379

(57) ABSTRACT

The method is for the renewal of an active identification data element (IDE) on a portable identification device (PID), the PID having at least a first IDE having active and valid initial states and a second IDE having inactive and invalid initial states, all the IDE having a valid state on the PID being destined to identify and have transaction data applied to an account associated to the PID which is not located on the PID, the IDE having an active state on the PID being used to accomplish a transaction, the method comprising the following steps:

a) changing the states of said first IDE from valid to invalid and from active to inactive; and

b) changing the state of said second IDE from inactive to active.

### CROSS-REFERENCE DATA

The present patent application claims the priority of the following patent applications: (1) provisional patent application No. 60/276,119 filed in the United States on Mar. 16, 2001; (2) international patent application No. PCT/IB01/00940 filed on May 28, 2001 and for which we have designated all the member states, this application has been filed at the World Intellectual Property Organization (WIPO); and (3) provisional patent application No. 60/294,448 filed on May 30, 2001.

### FIELD OF THE INVENTION

The present invention relates to portable identification devices, and more particularly to a system and method for the renewal of identification data on a portable identification device.

### BACKGROUND OF THE INVENTION

Portable identification devices (PID) such as smart cards, credit cards, debit cards, electronic wallets, encoded access keys, or other similar devices, are well known and commonly used. In the example of a credit card PID, this card comprises identification data in the form of a card number which includes a certain number of digits. An expiration date is also usually associated to a credit card. Other data can also be included on the card, for example the name of the cardholder. However, the credit card number represents the identification data of the card, given that the card number represents the data which is used for the purpose of identification of the cardholder's account at the financial institution that issued the card, for example the credit company in the case of a credit card. This identification data is hence used to apply to the account associated with the credit card monetary transaction made by means of the credit card.

Usually, the card number is printed or stamped directly onto the material of the card, for example by means of a press which will deform the card made of plastic in order for the card number to be presented in relief on the card surface. Thus, the card number identification data cannot be modified in any way other than by replacing the card by a new card provided with a new number. In the present specification, such identification data which cannot be modified on the PID will be identified by the expression “permanent identification data”.

A problem associated to such permanent identification data is that this principle allows the usage by others of the permanent identification data for fraudulent purposes. Indeed, in today's society, a credit card can for example be used to purchase a product or service by telephone, by verbally transmitting to a product or service provider the credit card's number and expiration date. Person to person product or service sales can also occur during which the permanent identification data will be indicated to the product or service provider. Sales through a computer linked to a network such as Internet can also be accomplished, during which the identification data is transmitted through this computer network. In all these cases, the credit card itself is not necessarily required, and the sale of the product or service can take place if the card's permanent identification data is known and if the account associated with this identification data is valid. If a third party becomes aware of the permanent identification data of the credit card of another person, then this third party could make a transaction on the basis of this knowledge, the debit related to the transaction being then applied to cardholder's account without his authorization. A third party can become aware of the permanent identification data of a card during any usage of this card: for example, if this data is transmitted by telephone, then the attendant of the service provider can keep the permanent identification data of the card for ulterior fraudulent usage; if this data is transmitted by Internet, a computer hack could enable a third party to intercept the data transmission for ulterior fraudulent usage; or else if this data is transmitted in a conventional fashion through the instrumentality of an interface machine located at the business place of a product or service provider, it often happens that the permanent identification data of the card appears on the copy of the receipt which is kept by the product or service provider, and a person having access to these receipts could then keep the permanent identification data of the card for ulterior fraudulent usage purposes.

As regards an electronic wallet, this PID is loaded with a certain amount of money by means of a suitable interface machine, and this amount of money is afterwards considered as being nested on the electronic wallet itself. When a transaction has to be accomplished by means of the electronic wallet, the amount of money associated with the transaction is transferred, by means of another suitable interface machine, from the electronic wallet to the recipient account of the product or service provider.

In the case of the electronic wallet, the permanent identification data associated therewith is useful particularly during the upload of money on the electronic wallet. Indeed, it is necessary to have access to an account number of a financial institution, and the permanent identification data stored in the electronic wallet is used to link the electronic wallet with the electronic wallet holder's account at the financial institution. It would hence be possible for a third party to have access fraudulently to the account of a person which holds an electronic wallet if another electronic wallet is programmed with the permanent identification data of the electronic wallet of the other person, to allow access to the account of this other person.

The PID can also be an encoded access key granting the access to the holder of the PID beyond any sort of gate, which can be real or virtual. This access key is provided with identification data which identifies the PID, and when the access beyond a gate is wanted, the identification data is verified and the access is granted if the identification data is valid.

### SUMMARY OF THE INVENTION

The present invention relates to a method for the renewal of an active IDE on a PID, said PID having at least a first IDE having active and valid initial states on said PID and a second IDE having inactive and invalid initial states on said PID, said first and second IDE being saved at a transaction institution and having an valid initial state at said transaction institution, all the IDE having a valid state at said transaction institution permitting to identify and to have transaction data applied to an account associated to said PID and located at said transaction institution, said IDE having an active state on said PID being used to accomplish a transaction, said method comprising the following steps:

a) changing the states of said first IDE from valid to invalid and from active to inactive on said PID;

b) changing the state of said second IDE from inactive to active on said PID; and

c) changing the state of said first IDE from valid to invalid at said transaction institution.

The present invention also relates to a method for the renewal of an IDE on a PID during an electronic transaction which is accomplished by means of said PID, said PID being associated to an account located at a transaction institution, said transaction institution comprising a valid IDE bank identifying said account, said PID comprising also said valid IDE bank, said method comprising the following steps:

a) transmitting an IDE called active IDE among said valid IDE of said PID to said transaction institution;

b) identifying at said transaction institution said account associated to said PID by identifying said valid IDE at said transaction institution corresponding to said active IDE;

c) applying transaction data representative of said transaction from said account associated to said PID;

d) changing the state of said active IDE of said PID and of said IDE corresponding to said active IDE at said transaction institution, from valid to invalid, in order for this IDE to be no longer usable to identify said account corresponding to said PID.

According to an embodiment, said active IDE will be renewed on said PID when one or many of following conditions are respected:

said active IDE has been transmitted by said PID;

a transaction has been accomplished by means of said active IDE, and a transaction confirmation message has been issued by said transaction institution to said PID;

a certain period of time has elapsed since the transmission of the active IDE;

a certain predetermined amount of transactions have been accomplished; and

the renewal of the active IDE has been manually commanded to said PID.

According to an embodiment, it is possible to restore said valid IDE bank on said PID and at said transaction institution.

According to an embodiment, said PID also has permanent identification data in addition to said IDE.

According to an embodiment, the IDE which have become invalid are kept in memory on said PID and at said transaction institution, for future reference, as well as the transaction data which has been applied to said account associated to said PID thanks to each IDE which has become invalid.

According to an embodiment, only one PID can be used to identify first and second distinct accounts.

According to an embodiment, each of said first and second accounts are located in distinct financial institutions.

According to an embodiment, said valid IDE bank on said PID is divided in first and second portions allowing to identify said first and second accounts, respectively.

The present invention also relates to a system for the renewal of an active IDE on a PID, said PID having at least a first IDE having active and valid initial states on said PID and a second IDE having inactive and valid initial states on said PID, said first and second IDE being saved in a resident memory of a transaction institution and having an valid initial state at said transaction institution, all the IDE having a valid state at said transaction institution allowing to identify and to have transaction data applied to an account associated to said PID and located in said resident memory of said transaction institution, said IDE having an active state on said PID and being used to accomplish a transaction, said system comprising:

a) means for changing the states of said first IDE from valid to invalid and from active to inactive on said PID;

b) means for changing the state of said second IDE from inactive to active on said PID; and

c) means for changing the state of said first IDE from valid to invalid in said resident memory of said transaction institution.

The present invention also relates to a system for the renewal of an IDE on a PID during an electronic transaction which is accomplished by means of said PID, said PID being associated to an account located at a transaction institution, said transaction institution comprising a valid IDE bank identifying said account, said PID comprising also said valid IDE bank, said system comprising:

a) means for transmitting to said transaction institution an IDE called active IDE among said valid IDE of said PID;

b) means for identifying at said transaction institution said account associated to said PID by identifying said valid IDE corresponding to said active IDE;

c) means for applying transaction data representative of said transaction to said account associated to said PID;

d) means for changing the state of said active IDE of said PID and of said IDE corresponding to said active IDE at said transaction institution, from valid to invalid, in order for this IDE to be no longer usable to identify said account corresponding to said PID.

The present invention also relates to a PID comprising:

an electronic chip having a microprocessor and a memory member being readable and writable;

a communication device linked to said electronic chip and allowing to send and receive data;

a user interface linked to said electronic chip; and

an IDE bank stored on said memory member and comprising at least two valid IDE allowing to identify an account located in a transaction institution.

The present invention also relates to a method for the renewal of an active IDE on a PID, said PID having at least a first IDE having active and valid initial states and a second IDE having inactive and valid initial states, all the IDE having a valid state on said PID being destined to identify and have transaction data applied to an account associated to said PID which is not located on said PID, said IDE having an active state on said PID being used to accomplish a transaction, said method comprising the following steps:

a) changing the states of said first IDE from valid to invalid and from active to inactive; and

b) changing the state of said second IDE from inactive to active.

The present invention also relates to a system for the renewal of an active IDE on a PID, said PID having at least a first IDE having active and valid initial states and a second IDE having inactive and valid initial states, all the IDE having a valid state on said PID being destined to identify and have electronic transaction data applied to an account associated to said PID which is not located on said PID, said IDE having an active state on said PID being used to accomplish a transaction, said system comprising:

a) means for changing the states of said first IDE from valid to invalid and from active to inactive; and

b) means for changing the state of said second IDE from inactive to active.

### DESCRIPTION OF THE DRAWINGS

In the annexed drawings:

FIG. 1 schematically shows a portable transaction device according to the present invention, as well as its communication link with an interface terminal; and

FIGS. 2a and 2b schematically and sequentially show the data transfer the state of the identification data elements in a portable transaction system according to the present invention.

### DETAILED DESCRIPTION OF THE EMBODIMENTS

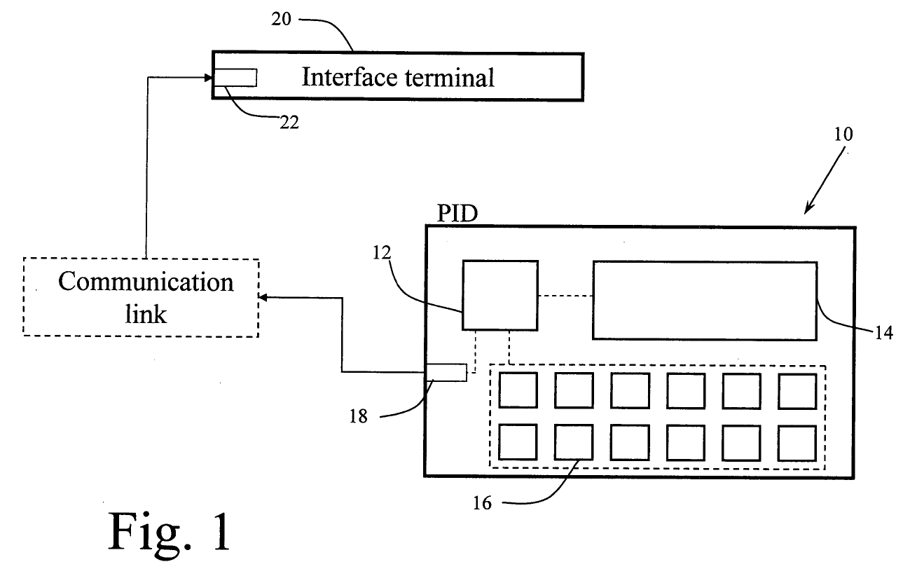

FIG. 1 shows a portable identification device (PID) 10 which can be a smart card such as a credit card and/or a debit card, an electronic wallet, an access key provided with access data which is encoded or not, or any other suitable portable identification device allowing to identify an account and/or a holder associated with this PID 10. An account associated to PID 10 can be an account located in an electronic memory resident at a financial institution, or more generally an account located in an institution responsible of verifying the identity of the holder of PID 10, in order to allow or refuse that an electronic transaction alters or not parameters of said electronic account according to predetermined conditions. The transaction can be a financial transaction or not. For example, within the framework of the present specification, a transaction can simply be a passage right beyond any sort of gate, as detailed hereinafter. Thus, the institution responsible of performing such a verification of the identity of the holder of PID 10 will be called, in the present specification, the transaction institution.

PID 10 comprises an electronic chip 12 linked to a suitable user interface, for example a display screen 14 and a keyboard 16. Chip 12 comprises a microprocessor and a memory member which can be read and written. The writing of data on the memory member of chip 12 is preferably governed by predetermined security conditions. According to an alternative embodiment of the invention, the memory member of chip 12 is a memory member which can be read only.

In addition, PID 10 comprises a communication device 18 linked to chip 12 and allowing PID 10 to communicate information to an interface terminal 20 having a complementary communication device 22. For example, communication device 18 can be an electromagnetic transmitter, notably of infrared waves or of data-carrying radio waves, while communication device 22 can be an infrared wave or data-carrying radio wave receiver. Generally, communication devices 18 and 22 can be any type of contact or contactless communication device allowing for PID 10 to temporarily communicate with interface terminal 20 and to transmit data to interface terminal 20. According to an advantageous embodiment of the invention, communication devices 18, 22 moreover allow for the data to be communicated in the opposite direction, i.e. from interface terminal 20 to PID 10.

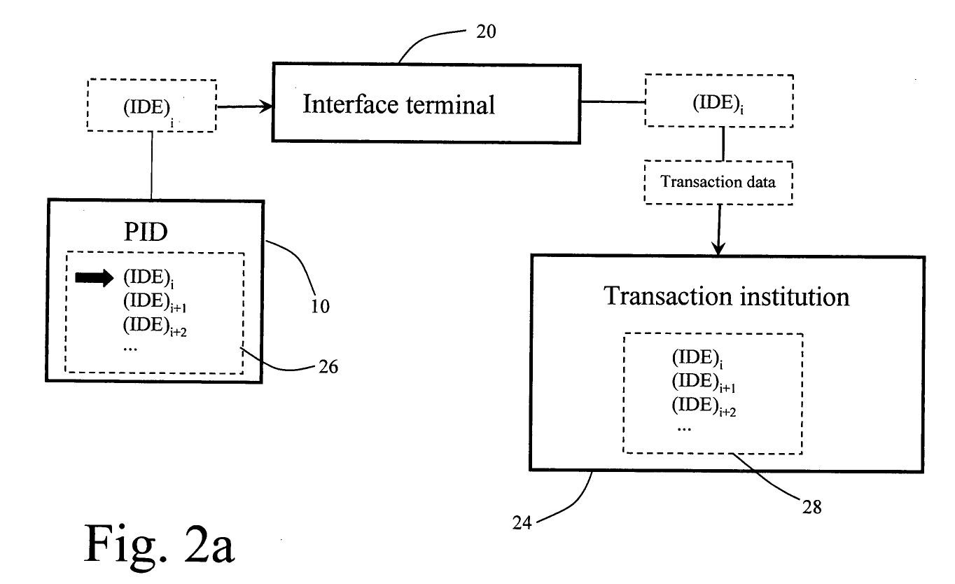

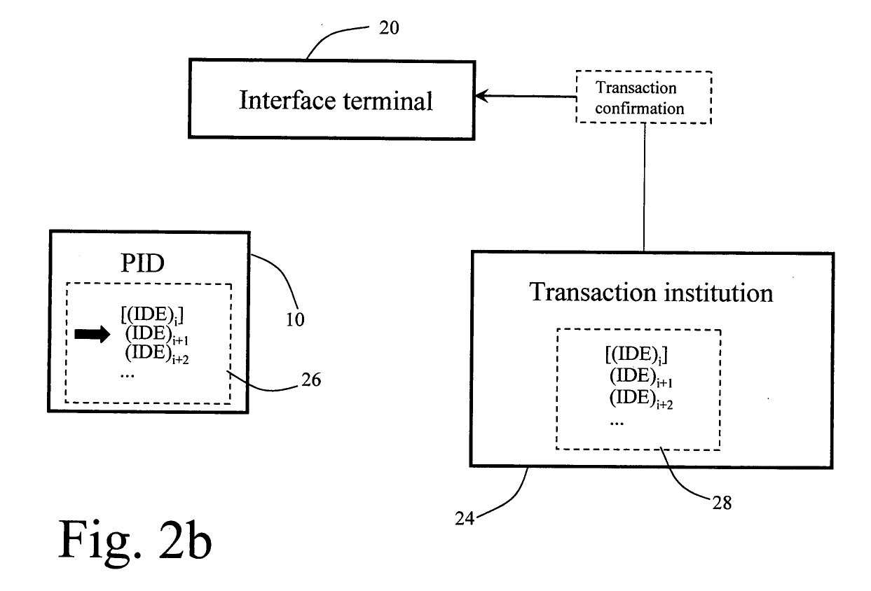

According to the present invention, PID 10 is used in a transaction system as illustrated in FIGS. 2a and 2b. In this transaction system, PID 10 can communicate data to an interface terminal 20, the latter being likely to communicate information to a transaction institution 24 in order to exchange information therewith. For example, interface terminal 20 can be a sales point interface terminal or even a portable interface machine integrated to a cellular phone, and transaction institution 24 can be a financial institution such as a bank.

PID 10 possesses a bank of identification data elements 26 which comprises at least two distinct identification data elements (IDE) which represent data which can for example a series of digits and/or of letters, or any other type of favorable data to identify an account to identify an account corresponding to PID 10 in the transaction institution. All the IDE on PID 10 have a state which is either active or inactive, and also which is either valid or invalid. The active state of an IDE means that this IDE will be the next to be used during a transaction performed by means of PID 10. Thus, one sole active IDE exists on PID 10 at any given moment, and all the other IDE have an inactive state. The valid state of an IDE on PID 10 means that this IDE, which is associated to the corresponding account of the transaction institution, identifies it in order to allow for a transaction to affect one or many parameters of this account by means of PID 10. Thus, all the valid IDE can be used in turn as active IDE to identity the account associated to PID 10.

According to an embodiment of the invention, the different IDE can be displayed on display screen 14 according to their respective states.

As illustrated in FIG. 2a, at a given moment, PID 10 has a certain number of IDE which have a valid state, namely (IDE)i, (IDE)i+1, (IDE)i+2, etc . . . The single IDE having an active state, namely (IDE)i, is highlighted by the arrow in FIG. 2a.

Transaction institution 24 also has an IDE bank 28 which comprises a certain number of IDE which are the same than that found on PID 10, namely (IDE)i, (IDE)i+1, (IDE)i+2, etc . . . At a given time, all the IDE which have a valid state on PID 10 also have a valid state at transaction institution 24. All the IDE which have a valid state at transaction institution 24 are associated to a corresponding account on PID 10 and identify this account.

FIGS. 2a and 2b sequentially illustrate an example of the present invention on the occasion of a transaction that one wishes to accomplish by means of PID 10 and at a transaction institution 24.

When a transaction must be accomplished, for example if goods or a service must be purchased, transaction data is provided to interface terminal 20 in a suitable fashion. The transaction data can be, for example, the price of the goods or of the service to be purchased, and the way of transmitting this transaction data can then be a computerized cash (not shown) which communicates electronically with interface terminal 20 to provide this transaction data thereto, or also interface terminal 20 can itself be provided with a keyboard (not shown) allowing to input transaction data.

In order for the transaction to be completed, a communication link is established between PID 10 and interface terminal 20 in a suitable manner, and the (IDE)i which has a valid and active state on PID 10 is transmitted from PID 10 to interface terminal 20. The (IDE)i and the transaction data are afterwards transmitted to transaction institution 24, where the account associated with PID 10 is identified and located thanks to the (IDE)i. If the IDE provided by interface terminal 20 to transaction institution 24 has a valid state at transaction institution 24, which is the case of the (IDE)i in the example illustrated in FIG. 2a, then the transaction data will modify one or many parameters of the account associated to PID 10 and identified by means of the (IDE)i. For example, if the transaction data is the price of the goods or of a service that the holder of PID 10 wishes to buy, then an amount corresponding to this price is debited from the account of transaction institution 24 associated to PID 10. This amount of money will be thereafter transmitted to the product or service seller by transaction institution 24 in a known manner.

Thereafter, as illustrated in FIG. 2b, a transaction confirmation message will be generated and sent by transaction institution 24 to interface terminal 20, to conclude the transaction. It is understood that this transaction confirmation message will be conveyed to interface terminal 20 only if predetermined conditions of the transaction institution are respected, should the case arise, for example if the monetary value of the transaction is inferior to the available credit in the account associated to PID 10. According to an embodiment of the invention, the transaction confirmation message can also be conveyed from interface terminal to PID 10.

Once the confirmation message is sent, the state of the (IDE)i which has been used to identify the account associated to PID 10 will be changed from valid to invalid at transaction institution 24. Since only valid IDE can be used to identify and allow for transaction data to affect parameters of the account associated to PID 10, the (IDE)i which is now invalid can no longer be used to identify or to allow for transaction data to applied to the account associated to PID 10, as suggested by the fact that the (IDE)i is bracketed in FIG. 2b. PID 10 will also modify the state of (IDE)i for it to become invalid and inactive on PID 10, and will modify the state of the next valid IDE from the IDE bank 26 on PID 10, namely the (IDE)i+1, for it to become active. In this fashion, the next IDE which will be used by PID 10 to identify and apply transaction data to the account associated to PID 10 will be the (IDE)i+1. Since the (IDE)i+1 is always valid at transaction institution 24, this new IDE can hence be successfully used as long as the other conditions peculiar to transaction institution 24 are met, for example that the credit limit be observed, in the case of a credit institution. The IDE can thus be considered as having been renewed on PID 10.

It is to be noted that the active IDE can be renewed, from the (IDE)i to the (IDE)i+1, when one or many predetermined conditions, which are programmed on chip 12, are respected. For example, the active IDE can be renewed on PID 10 when one or many of the following conditions are respected:

the active IDE has been transmitted by PID 10;

a transaction has been accomplished. This implies that a communication link between PID 10 and interface terminal 20 enables the communication from and to PID 10, since in order for PID 10 to be informed that the transaction has actually been accomplished, a transaction confirmation message has to be communicated from interface terminal 20 to PID 10;

a certain period of time has elapsed since the transmission of the IDE without a confirmation or cancellation message having been sent back to PID 10;

the renewal of the active IDE has been manually commanded to PID 10, for example by means of keyboard 16; and/or

any other suitable condition.

According to an embodiment of the invention, an active IDE on PID 10 which becomes inactive, becomes also automatically invalid. This prevents an IDE from being used twice, and hence from being recognized as a valid IDE by the transaction institution.

According to an embodiment of the invention, a valid IDE at the financial institution 24 will see its state become invalid only under the same conditions which would modify the state of the same IDE from valid to invalid on PID 10, and vice-versa. For example, if an IDE becomes automatically invalid on PID 10 after a single utilization to accomplish a transaction as an active IDE, than this same IDE would become invalid automatically at transaction institution 24 after a transaction has been accomplished in the account associated to the IDE which has been used to identify the account associated to PID 10.

According to an advantageous embodiment of the invention, each IDE is used once only and becomes automatically invalid after this single utilization, in order to prevent fraud based on the knowledge of the identification data of PID 10. Indeed, once an IDE has been used to accomplish a transaction, it becomes invalid and hence cannot be reused to identify the account associated to PID 10. Consequently it is of no consequence that this obsolete IDE falls into the wrong hands after a transaction is accomplished.

According to an embodiment of the invention, all the IDE on PID 10 are uploaded to chip 12 by transaction institution 24 in a suitable manner, before PID 10 is handed back to its owner. When all the IDE which form the IDE bank 26 on PID 10 have become invalid, the owner of PID 10 could then ask that a new PID 10 be handed to him by transaction institution 24. It is envisioned, according to this embodiment, that a warning message be issued by PID 10, for example by means of display screen 14 or of interface terminal 20, when IDE bank 26 is on the point of being consumed, to favor the renewal at opportune time of PID 10 by a new PID 10 provided with new IDE. Alternatively, a new bank of valid IDE could be uploaded to a same PID 10, by replacing the invalid IDE, by means of a suitable interface machine, and as long as communication device 18 of PID 10 allows the reception of data in addition to the transmission of data.

According to an embodiment of the invention, communication device 18 of PID 10 allows for information to be uploaded to chip 12 by means of a suitable interface machine, for example interface terminal 20; and PID 10 has a small maximum number of IDE memorized on its chip 12. Thus, regularly, new IDE can be uploaded from the transaction institution to replace the consumed IDE. This permits notably to limit the number of transaction which can be made with a found or stolen PID 10, since the number of valid IDE available on PID 10 is low. A signal issued automatically by the transaction institution and/or by PID 10 itself could trigger the reloading of the IDE bank of PID 10 and of the IDE bank of transaction institution 24 associated to the account of PID 10.

According to an embodiment of the invention, PID 10 has permanent identification data in addition to the temporary IDE used in combination with the IDE to identify the account of PID 10, without however allowing to apply transaction data thereto. For example, this permanent identification data could be printed on the card on top of being saved on chip 12, and could allow for the owner of the IDE to obtain various information concerning his account at the transaction institution, for example the amount of remaining usable credit in the case of an account hosted by a credit institution. However, the permanent identification data alone would not allow for a transaction to be applied on the account associated to PID 10.

According to an embodiment of the invention, PID 10 does not comprise an integrated user interface 14, 16. According to another embodiment of the invention, PID 10 does not comprise an integrated user interface 14, 16, but PID 10 could be put in communication with a user interface external to and distinct from PID 10, for example a portable interface machine such as an interface machine integrated to a cellular phone.

According to an embodiment of the invention, obsolete IDE, i.e. which have become invalid, are kept memorized on PID 10 and in data banks of transaction institution 24, for future reference, along with the transaction data which has been applied to the account associated to PID 10 thanks to each obsolete IDE, although these obsolete IDE could not be used for identifying or for applying transaction data to the account of PID 10. Thus, it would be possible to inspect the parameters of the transactions which are accomplished in a given account, and by means of which IDE each transaction has been accomplished.

According to an embodiment of the invention, only one PID 10 can be used to access more than one account located in one or many transaction institutions. According to this embodiment, PID 10 could have one or many IDE lists used to identify different accounts associated to PID 10: either one sole list is used to access an account corresponding to that list, each account having from then on a distinct list associated thereto.

It is understood that, in the present specification, the expression “transaction institution” is used in a general sense. Thus, the transaction made can be a financial one or not. For example, the financial institution can be a credit company, a bank, an institution managing access codes allowing access to areas protected by gates requiring an access key, etc. Furthermore, it can be envisioned that the account which will be affected by a transaction such as a financial transaction, is not managed by the same institution which manages issues related to the verification of an IDE for the purpose of authorizing a transaction: thus provision could be made for a first IDE verification institution and a second account management institution distinct from the verification institution. In view of this embodiment of the present invention, the expression “transaction institution” should be understood as including the verification institution and the account management institution, even if these two institutions are actually distinct.

According to an embodiment of the invention, the IDE located in IDE bank 28 at transaction institution 24 are not provided with a active/inactive state, but only with a valid/invalid state. This allows the owner of PID 10 to perform transactions which cannot be transmitted immediately to the transaction institution, for example off-line financial transactions where the product or service seller notes down the active IDE of PID 10, but does not contact the financial institution immediately to report that the transaction has taken place.

Thus, since every valid IDE at the financial institution could then be used to identify the account associated to PID 10 and apply transaction data thereto, many sequential transactions could be made by the holder of PID 10 with a series of valid IDE without the information concerning these transactions being immediately transmitted to the transaction institution. Thereafter, when different transactions will be submitted to the transaction institution to affect one or many parameters of the account associated to PID 10, in an ordered fashion or not, they will be accepted since they were submitted in association with valid IDE.

According to an alternative embodiment of the invention, only the active IDE in the IDE list can be used to identify an account and to apply transaction data thereto. In such a case, transaction institution 24 would be required to assign an active/inactive state to each IDE of the IDE list 28 located at transaction institution 24, in addition to a valid/invalid state. The IDE which would have an active state at the transaction institution 24 would initially be the same than that which has an active state on PID 10, and would be thereafter renewed according to the same conditions than the active IDE on PID 10. Alternatively, only a small number of valid IDE would be considered as active at transaction institution 24.

According to an embodiment of the invention, all the valid IDE on PID 10 are saved on the memory of PID 10, and all the IDE which become invalid are actually erased from the memory of PID 10. Similarly, all the valid IDE at the transaction institution 24 are saved in memory, and all the IDE which become invalid are actually erased from the memory of transaction institution 24.

It is understood that the “valid” and “active” states, in the present specification, are named so as a rough guide, and it is not obligatory that they be named as such in different embodiments of the invention. For example, an IDE having a valid state could simply be an IDE which is present in the data bank of PID 10, this IDE being simply erased from PID 10 when it is not valid anymore, thus becoming “invalid”. Also, the active IDE can be randomly chosen between the valid IDE upon the transaction being made, or also a specific order can be followed, in which case the active IDE is not necessarily provided with a specific condition in the memory of chip 12 of PID 10; it is however understood that an IDE is considered active when it is transmitted by PID 10 for the purpose of identification of the account corresponding to PID 10.

It is understood that it is envisioned to use any form of transaction securing means, for example by the encoding or encrypting of the exchanged data, and/or any form of securing means of the usage of PID 10, for example by the additional provision on PID 10 of a biometric reader which would compare biometric data read with pre-saved biometric data representative of a biometric parameter of the holder of PID 10. For example, a fingerprint reader could be provided on PID 10, and every use of PID 10 would have to be validated beforehand by the acquisition of the fingerprint of the holder of PID 10 by this fingerprint reader.

1. Method for the renewal of an active IDE on a PID, said PID having at least a first IDE having active and valid initial states on said PID and a second IDE having inactive and valid initial states on said PID, said first and second IDE being saved at a transaction institution and having an valid initial state at said transaction institution, all the IDE having a valid state at said transaction institution permitting to identify and to have transaction data applied to an account associated to said PID and located at said transaction institution, said IDE having an active state on said PID being used to accomplish a transaction, said method comprising the following steps:
a) changing the states of said first IDE from valid to invalid and from active to inactive on said PID;
b) changing the state of said second IDE from inactive to active on said PID; and
c) changing the state of said first IDE from valid to invalid at said transaction institution.

2. Method for the renewal of an IDE on a PID during an electronic transaction which is accomplished by means of said PID, said PID being associated to an account located at a transaction institution, said transaction institution comprising a valid IDE bank identifying said account, said PID comprising also said valid IDE bank, said method comprising the following steps:
a) transmitting an IDE called active IDE among said valid IDE of said PID to said transaction institution;
b) identifying at said transaction institution said account associated to said PID by identifying said valid IDE at said transaction institution corresponding to said active IDE;
c) applying transaction data representative of said transaction from said account associated to said PID;
d) changing the state of said active IDE of said PID and of said IDE corresponding to said active IDE at said transaction institution, from valid to invalid, in order for this IDE to be no longer usable to identify said account corresponding to said PID.

3. Method according to claim 2, wherein said active IDE will be renewed on said PID when one or many of following conditions are respected:
said active IDE has been transmitted by said PID;
a transaction has been accomplished by means of said active IDE, and a transaction confirmation message has been issued by said transaction institution to said PID;
a certain period of time has elapsed since the transmission of the active IDE;
a certain predetermined amount of transactions have been accomplished; and
the renewal of the active IDE has been manually commanded to said PID.

4. Method according to claim 2, wherein it is possible to restore said valid IDE bank on said PID and at said transaction institution.

5. Method according to claim 2, wherein said PID also has permanent identification data in addition to said IDE.

6. Method according to claim 2, wherein the IDE which have become invalid are kept in memory on said PID and at said transaction institution, for future reference, as well as the transaction data which has been applied to said account associated to said PID thanks to each IDE which has become invalid.

7. Method according to claim 2, wherein only one PID can be used to identify first and second distinct accounts.

8. Method according to claim 7, wherein each of said first and second accounts are located in distinct financial institutions.

9. Method according to claim 7, wherein said valid IDE bank on said PID is divided in first and second portions allowing to identify said first and second accounts, respectively.

10. System for the renewal of an active IDE on a PID, said PID having at least a first IDE having active and valid initial states on said PID and a second IDE having inactive and valid initial states on said PID, said first and second IDE being saved in a resident memory of a transaction institution and having an valid initial state at said transaction institution, all the IDE having a valid state at said transaction institution allowing to identify and to have transaction data applied to an account associated to said PID and located in said resident memory of said transaction institution, said IDE having an active state on said PID being used to accomplish a transaction, said system comprising:
a) means for changing the states of said first IDE from valid to invalid and from active to inactive on said PID;
b) means for changing the state of said second IDE from inactive to active on said PID; and
c) means for changing the state of said first IDE from valid to invalid in said resident memory of said transaction institution.

11. System for the renewal of an IDE on a PID during an electronic transaction which is accomplished by means of said PID, said PID being associated to an account located at a transaction institution, said transaction institution comprising a valid IDE bank identifying said account, said PID comprising also said valid IDE bank, said system comprising:
a) means for transmitting to said transaction institution an IDE called active IDE among said valid IDE of said PID;
b) means for identifying at said transaction institution said account associated to said PID by identifying said valid IDE corresponding to said active IDE;
c) means for applying transaction data representative of said transaction to said account associated to said PID;
d) means for changing the state of said active IDE of said PID and of said IDE corresponding to said active IDE at said transaction institution, from valid to invalid, in order for this IDE to be no longer usable to identify said account corresponding to said PID.

12. PID comprising:
an electronic chip having a microprocessor and a memory member being readable and writable;
a communication device linked to said electronic chip and allowing to send and receive data;
a user interface linked to said electronic chip; and
an IDE bank stored on said memory member and comprising at least two valid IDE allowing to identify an account located in a transaction institution.

13. Method for the renewal of an active IDE on a PID, said PID having at least a first IDE having active and valid initial states and a second IDE having inactive and valid initial states, all the IDE having a valid state on said PID being destined to identify and have transaction data applied to an account associated to said PID which is not located on said PID, said IDE having an active state on said PID being used to accomplish a transaction, said method comprising the following steps:
a) changing the states of said first IDE from valid to invalid and from active to inactive; and
b) changing the state of said second IDE from inactive to active.

14. System for the renewal of an active IDE on a PID, said PID having at least a first IDE having active and valid initial states and a second IDE having inactive and valid initial states, all the IDE having a valid state on said PID being destined to identify and have electronic transaction data applied to an account associated to said PID which is not located on said PID, said IDE having an active state on said PID being used to accomplish a transaction, said system comprising:
a) means for changing the states of said first IDE from valid to invalid and from active to inactive; and
b) means for changing the state of said second IDE from inactive to active.
